(19) United States
(12) Patent Application Publication
(10) Pub. No.: US 2017/0041078 A1
(43) Pub. Date: Feb. 9, 2017

(54) METHOD OF NON-LINEARITY COMPENSATION IN OPTICAL FIBRE COMMUNICATIONS

(71) Applicant: Aston University, Birmingham, West Midlands (GB)

(72) Inventors: Son Thai LE, Birmingham, West Midlands (GB); Andrew ELLIS, Kingsmead, Northwich, Cheshire (GB)

(73) Assignee: Aston University, Birmingham, West Midlands (GB)

(21) Appl. No.: 15/302,573

(22) PCT Filed: Apr. 7, 2015
(86) PCT No.: PCT/GB2015/051063

§ 371 Date: Oct. 7, 2016

(30) Foreign Application Priority Data
Apr. 8, 2014 (GB) 1406271.5

(51) Int. Cl. H04B 10/2543; H04B 10/61

(52) U.S. Cl. CPC H04B 10/2543; H04B 10/6163; H04B 2210/252

(57) ABSTRACT

A nonlinearity compensation technique for a CO-OFDM transmission system in which a proportion (e.g. up to 50%) of OFDM subcarriers is transmitted along with a phase-conjugate copy (PCP) on another subcarrier (replacing a data carrying subcarrier) to enable nonlinear distortion compensation. Nonlinear distortion experienced by closely spaced subcarriers in an OFDM system is highly correlated. The PCPs are used at the receiver to estimate the nonlinear distortion (e.g. nonlinear phase shift) of their respective original subcarriers and other subcarriers close to the PCP. With this technique, the optical fibre nonlinearity due to the Kerr effect in OFDM systems can be effectively compensated without the complexity of DBP or 50% loss in capacity of the phase conjugate twin wave (PC-TW) technique. Moreover, the technique proposed herein can be effectively implemented in both single polarization and PMD systems, in both single channel and WDM systems.

### FIELD OF THE INVENTION

The invention relates to a technique of compensating for non-linear effects observed in a signal transmitted along an optical fibre. In particular, the invention relates to a method of compensating for optical fibre non-linearity in an coherent optical orthogonal frequency-division multiplexing (CO-OFDM) scheme.

### BACKGROUND TO THE INVENTION

Theoretically the capacity of a fixed bandwidth communications channel is logarithmically proportional to the signal-to-noise ratio [1]. As a result, the capacity of optical fibre communications channel should increase monotonically with the transmit signal power. However, the nonlinear distortion due to Kerr effect limits the maximum optical power that could be launched into an optical fibre [2, 3]. Fibre Kerr nonlinearity effect thus sets an upper bound on the maximum achievable data rate in optical fibre communications.

There have been extensive efforts in attempting to supress the Kerr nonlinearity limit through several nonlinearity compensation techniques. Digital-back-propagation (DBP) is an effective nonlinearity compensation method, which removes the nonlinear distortion by inversing the distorted signal at the receiver digitally [4]. This technique is based on the fact that the propagation of pulses in optical fibre can be accurately modelled by the nonlinear Schrodinger equation (NLSE). As a result, all deterministic distortion introduced by the fibre can be compensated at the receiver by inverting the NLSE.

The idea of applying DBP has become realistic recently, owing to the advantage of coherent detection, which provides the full information of the received signal (both amplitude and phase) at the receiver. A number of investigations on the performance of DBP have been carried out with various transmission configurations [4, 5, 6]. However, DBP demonstrates impractically high complexity due to numerous computation steps under the nonlinear interaction. Furthermore, in wavelength-division multiplexed (WDM) systems the effectiveness of DBP is significantly reduced as the neighbouring WDM channels are unknown to the compensator.

Digital [7] and optical [8, 9] mid-link phase conjugations (ML-PCs) are other known nonlinear compensation techniques that conjugate the signal phase at the mid-point of the transmission link in order to achieve cancellation of the nonlinear phase shift at the end of the link. ML-PC modifies the transmission link by inserting a phase conjugator at the middle point of the link, and requires near mirror-imaged power evolutions with respect to the phase conjugator. However, in order to achieve a meaningful performance improvement with ML-PC scheme, the entire transmission link needs to be homogeneous and the signal power evolution profile before and after ML-PC needs to be symmetry to emulate as mirrored image. Such requirement significantly reduces the flexibility in an optically routed network. Moreover, the additional hardware (phase conjugator) is a significant drawback of ML-PC technique.

Recently a novel nonlinear compensation technique called phase-conjugated twin waves (PC-TW) has been proposed [10]. PC-TW is a transmitter-based technique that can be implemented with minimal additional hardware or signal processing. In this scheme, the signal complex wave form and its phase-conjugate are simultaneously transmitted in x- and y-polarization states and the nonlinear signal distortion can be subsequently mitigated at the receiver through coherent superposition. The principle of operation is that the conjugate accumulates the same nonlinearity as the signal. At the receiver, a conjugate process inverts this nonlinearity, so that when added to a copy of the signal, the data signals add (boosting SNR) whilst the nonlinear terms subtract. The PC-TW provides a simple and effective solution in compensating optical fibre nonlinearity as it requires only an additional conjugate-and-add operation per symbol prior to symbol detection. However, the one serious shortcoming of PC-TW is that it accommodates half the transmission capacity. In addition to this, PC-TW can be applied effectively only in polarization division multiplexed (PDM) systems.

Orthogonal frequency-division multiplexing (OFDM) is a widely used digital modulation/multiplexing technique. Coherent optical-OFDM (CO-OFDM) scheme is being considered as a promising technology for future high-speed (e.g., >100 Gb/s per-channel data rate) optical transport systems [11-13]. CO-OFDM provides some inherent advantages, namely high spectral efficiency, high resilience towards linear impairment, such as optical fibre chromatic dispersion (CD) and polarization mode dispersion (PMD), simpler channel estimation and compensation technique. However, CO-OFDM suffers from a number of nonlinear effects, especially the four-wave-mixing (FWM) due to the narrow and equal spacing of subcarriers. As a result, compensation of optical fibre nonlinearity for CO-OFDM is far more critical compared with any conventional schemes.

Several nonlinear mitigation techniques have been proposed for CO-OFDM transmissions, such as pre-and post-compensation [14, 15] or pilot-tone based fibre nonlinearity compensation [16]. However, the benefits of these techniques are insignificant and they are even ineffective in optical fibre links that do not have specific dispersion maps. As of to date, a simple and effective optical fibre nonlinearity compensation technique for CO-OFDM has still not been proposed.

### SUMMARY OF THE INVENTION

At its most general, the present invention proposes a nonlinearity compensation technique for a CO-OFDM transmission system in which at least one of the OFDM subcarriers is transmitted along with a phase-conjugate copy (PCP) on another subcarrier (replacing a data carrying subcarrier)to enable nonlinear distortion compensation. For an OFDM system, the nonlinear distortion experienced by closely spaced subcarriers is highly correlated, so that in addition to compensating the nonlinearity in the original OFDM subcarrier, optionally one or more additional adjacent (or closely spaced) sub-carriers may have their non-linear distortion estimated and thus subsequently compensated. In this scheme, a portion of the OFDM subcarriers (e.g. up to 50%) are transmitted as phase-conjugates of other subcarriers. The PCPs are used at the receiver to estimate the nonlinear distortion (e.g. nonlinear phase shift) of their respective original subcarriers and other subcarriers close to the PCP. With this technique, the optical fibre nonlinearity due to the Kerr effect in OFDM systems can be effectively compensated without the complexity of DBP or 50% loss in capacity of the phase conjugate twin wave (PC-TW) technique discussed above. Moreover, the technique proposed herein can be effectively implemented in both single polarization and PMD systems, in both single channel and WDM systems.

According to a first aspect of the invention, there is provided a method of preparing a data signal for transmission along an optical fibre, the method comprising: mapping an information symbol to a first subcarrier in an orthogonal frequency-division multiplexing (OFDM)-encoded data signal; and mapping a complex conjugate (also referred to herein as a phase conjugate) of the information symbol to a second subcarrier in the OFDM-encoded data signal, the second subcarrier neighbouring the first subcarrier in the frequency domain. Upon receiving the OFDM-encoded data signal, the received information symbol and the received information symbol corresponding to the complex conjugate can be processed to yield information about a nonlinear distortion experienced by the OFDM data signal, as explained below. The estimate of the nonlinear distortion calculated in this way may be used to compensate for nonlinear distortion in information symbols from additional surrounding subcarriers. In this way, the overhead of the phase conjugates can be less than 50%, i.e. less than that taken required if an entire conjugate copy were used (such as in the PC-TW technique discussed above).

The OFDM-encoded signal may be considered to comprise a plurality of nonlinearity compensation information symbol pairs, each pair comprising an information symbol carrying a piece of data and the complex conjugate of that information symbol conveyed on respective subcarriers. By spacing the nonlinearity compensation information symbol pairs through the band of subcarriers, the invention can provide accurate nonlinearity compensation across the frequency range of the OFDM-encoded data signal at relatively low bandwidth overhead.

Thus, the method may comprise: mapping a plurality of nonlinearity compensation information symbol pairs into respective pairs of subcarriers in an orthogonal frequency-division multiplexing (OFDM)-encoded data signal, each of the plurality of nonlinearity compensation information symbol pair comprising: a data information symbol mapped to a first subcarrier; and a complex conjugate of the data information symbol mapped to a second subcarrier, wherein the second subcarrier neighbours the first subcarrier in the frequency domain.

The plurality of nonlinearity compensation information symbol pairs may be regularly spaced through the frequency distribution of subcarriers in the OFDM-encoded data signal, e.g. separated by 1, 2, 3, 4, 5 or more subcarriers conveying information symbols which do not have a corresponding phase conjugate.

The proportion of subcarriers in the OFDM-encoded optical data signal which convey complex conjugates of data information symbols carried by other subcarriers may be 50% or less, e.g. 30% or less, 25% or less or 20% or less. Preferably the proportion is more than 10%.

Herein, reference to “neighbouring” in the frequency domain may mean that the first and second subcarriers are nearby to one another, e.g. separated by no more than five and preferably 3 or fewer subcarriers. In practice, the first and second subcarriers may be close enough in frequency for their nonlinear phase shifts to exhibit a high degree of correlation. Preferably, the first subcarrier is adjacent to the second subcarrier in a frequency distribution of subcarriers in the OFDM-encoded optical data signal.

After the information symbols are mapped to their respective subcarriers, the OFDM-encoded data signal may be transmitted in a conventional manner, e.g. by applying an inverse fast Fourier transform to the OFDM-encoded data signal to generate a time-domain signal; modulating an optical carrier with the time-domain signal; and transmitting the optical carrier through an optical fibre.

The nonlinearity compensation of the invention may be improved by creating a dispersion symmetry along the transmission link. The method may thus include applying electrical dispersion pre-compensation to the OFDM-encoded data signal, e.g. before the inverse fast Fourier transform is performed.

The transmission preparation process according to the first aspect may be performed by a suitably programmed computer. The process may be part of a conventional OFDM (and in particular a CO-OFDM) system, e.g. operating on the data after symbol mapping but before the inverse fast Fourier transform is performed. The first aspect of the invention may thus also provide a computer program product having computer-readable instructions stored thereon, which when executed by a computer cause the computer to perform a method as set out above.

According to a second aspect, the present invention provides a method of compensating for optical fibre nonlinearity, the method comprising: receiving an orthogonal frequency-division multiplexing (OFDM)-encoded optical data signal from an optical fibre; detecting a first received information symbol from a first subcarrier of the OFDM-encoded optical data signal; detecting a second received information symbol from a second subcarrier in the OFDM-encoded optical data signal, wherein the second subcarrier neighbours the first subcarrier in the frequency domain, and wherein the second received information symbol is a phase conjugated pilot for the first received information symbol; and compensating for a nonlinear phase shift in the first received information symbol based on the second received information symbol. The received OFDM-encoded optical data signal may be produced by the method of the first aspect of the invention. Accordingly features of the first aspect of the invention discussed above may be shared by the second aspect of the invention and are not discussed again.

The term “phase conjugated pilot for the first received information symbol” may mean that the second received information symbol was encoded as the complex conjugate (phase conjugate) of the information symbol that was original encoded on to the first subcarrier. However, due to nonlinear effects experience by the OFDM-encoded optical data signal during transmission, the first received information symbol and second received information symbol will no longer by complex conjugates of one another. The invention makes use of the relationship between the two information symbols when they were originally encoded to compensate for the nonlinear effects.

Compensating for a nonlinear phase shift in the first received information symbol may include averaging the first received information symbol and the conjugation of the second received information symbol.

As discussed above, the first and second subcarriers may be nearby to one another in the frequency distribution of subcarriers, e.g. separated by no more than five and preferably 3 or fewer subcarriers. In practice, the first and second subcarriers may be close enough in frequency for their nonlinear phase shifts to exhibit a high degree of correlation. Preferably, the first subcarrier is adjacent to the second subcarrier in a frequency distribution of subcarriers in the OFDM-encoded optical data signal.

The method may include calculating an estimated nonlinear distortion based on the first received information symbol and the second received information symbol. Advantageously, this estimated nonlinear distortion may be used to compensate for nonlinear effects experienced by other information symbols. This means that compensation can be performed without having to provide a complex conjugate for every transmitted information symbol. Thus, the method may include detecting a third received information symbol from a third subcarrier of the OFDM-encoded optical data signal, and compensating for a nonlinear phase shift in the third received information symbol based on the estimated nonlinear distortion. The compensation is particularly effective if the third subcarrier neighbours the first subcarrier in the frequency domain, i.e. is separated from it by five or fewer intervening subcarriers. If the number of subcarriers is big enough or the signal bandwidth is small enough, the first subcarrier may be separated from the third subcarrier by five or more intervening subcarriers, e.g. 6, 7, 8 or 9 or more intervening subcarriers.

Indeed, the estimated nonlinear distortion may be used to compensate for a nonlinear distortion in a plurality of received information symbols conveyed by a plurality of subcarriers located around the first subcarrier in the frequency domain.

Similarly to the first aspect, the second aspect of the invention is particularly useful when the received signal has a plurality of information symbol conjugate pairs encoded therein. If the conjugate pairs are spread through the frequency band of the OFDM-encoded signal, nonlinear compensation may be performed on the information symbol conveyed by every subcarrier, regardless of whether it has a conjugate pair or now.

Accordingly, the second aspect of the invention may also be expressed as a method of compensating for optical fibre nonlinearity, the method comprising: receiving an orthogonal frequency-division multiplexing (OFDM)-encoded optical data signal from an optical fibre; detecting a first pair of nonlinearity compensation information symbols from a first pair of subcarriers in the OFDM-encoded optical data signal, the first pair of nonlinearity compensation information symbols comprising: a first received information symbol from a first subcarrier of the OFDM-encoded optical data signal, and a second received information symbol from a second subcarrier in the OFDM-encoded optical data signal, wherein the second subcarrier neighbours the first subcarrier in the frequency domain, and wherein the second received information symbol is a phase conjugated pilot for the first received information symbol; detecting a second pair of nonlinearity compensation information symbols from a second pair of subcarriers in the OFDM-encoded optical data signal, the second pair of nonlinearity compensation information symbols comprising: a third received information symbol from a third subcarrier of the OFDM-encoded optical data signal, and a fourth received information symbol from a fourth subcarrier in the OFDM-encoded optical data signal, wherein the fourth subcarrier neighbours the third subcarrier in the frequency domain, and wherein the fourth received information symbol is a phase conjugated pilot for the third received information symbol; calculating a first estimated nonlinear distortion based on the first received information symbol and the second received information symbol; calculating a second estimated nonlinear distortion based on the third received information symbol and the fourth received information symbol; detecting a plurality of received information symbols conveyed by a plurality of subcarriers located between the first pair of subcarriers and the second pair of subcarriers in the frequency domain of the OFDM-encoded optical data signal; and compensating for a nonlinear phase shift in each of the plurality of received information symbols based on the first estimated nonlinear distortion and the second estimated nonlinear distortion.

The compensating step itself may be performed in a number of ways. For example, the same estimated nonlinear distortion calculated for a given conjugate pair may be used to compensate the information symbols is all subcarriers that are closest to that conjugate pair. Thus, the method may comprise: determining if the subcarrier of each respective received information symbol is closer to the first pair of subcarriers or the second pair of subcarriers in the frequency domain of the OFDM-encoded optical data signal; if the subcarrier is closer to the first pair of subcarriers, applying the first estimated nonlinear distortion to its respective received information symbol; and if the subcarrier is closer to the second pair of subcarriers, applying the second estimated nonlinear distortion to its respective received information symbol.

Alternatively, the nonlinear distortion may be assumed to vary in a certain way between conjugate pairs. For example, it may be assumed that the nonlinear distortion varies approximately in a linear fashion between adjacent conjugate pairs, especially if the conjugate pairs are relatively close in frequency. The method may thus include interpolating a linear variation of estimated nonlinear distortion with frequency based on the first estimated nonlinear distortion and the second estimated nonlinear distortion, wherein compensating for a nonlinear phase shift in each of the plurality of received information symbols comprises applying an interpolated estimated nonlinear distortion to each of the plurality of received information symbols based on the frequency of its subcarrier.

Similarly to the first aspect, the second aspect of the invention may be implemented on a suitably programmed computer executing software instructions that correspond to the method steps outlined above.

In summary, the phase-conjugate pilot scheme proposed above can be implemented in a simple, low cost and flexible manner and may be transparent to modulation format or fibre link properties. Since the technique is a digital, it can be applied in any optical links (with or without dispersion compensating modules), ranging from short distance to long-haul links without any hardware modification and requirements, thereby offering flexibility in implementation.

### BRIEF DESCRIPTION OF THE DRAWINGS

Examples of the invention are discussed below with reference to the accompanying drawings, in which:

FIG. 1 is a schematic diagram showing the relationship between a phase-conjugated pilot and a correlated subcarrier;

FIG. 2 is a block diagram of a polarization division multiplexed (PDM) coherent optical orthogonal frequency-division multiplexing (CO-OFDM) system suitable for implementing a non-linearity compensation technique that is an embodiment of the invention;

FIG. 3 is a block diagram of the receiver shown in FIG. 2;

FIG. 4 is a graph showing Q-factor as a function of launch power for a plurality of signals transmitted through the system of FIG. 2 when using a non-linearity compensation technique that is an embodiment of the invention;

FIG. 5 is a set of received constellation diagrams for the system in FIG. 2, where each received constellation diagram corresponds to a different amount of phase-conjugated pilot overhead when using a non-linearity compensation technique that is an embodiment of the invention; and

FIG. 6 is a graph showing the Q-factor improvement as a function of phase-conjugated pilot overhead when using a compensation technique that is an embodiment of the invention.

### DETAILED DESCRIPTION; FURTHER OPTIONS AND PREFERENCES

The concept behind the compensation technique of the invention can be understood in terms of a comparison with the known phase conjugate twin-wave (PC-TW) concept [10] discussed above. The PC-TW concept operates by transmitting a complex signal waveform and its phase conjugate in x- and y-polarizations. The compensation technique of the present invention differs from this in that the entire signal is not copied. Instead, the compensation technique of the invention allocates one or more subcarriers in an OFDM system for the purpose of transmitting a so-called phase-conjugated pilot signal. Each phase-conjugated pilot signal is a phase conjugate of a “real” data signal transmitted on another of the subcarriers. Since the frequency spacing in an OFDM system is often small, neighbouring subcarriers experience similar nonlinear distortion while propagating in an optical fibre. Thus, at the end of the optical link, the nonlinear phase shifts on neighbouring subcarriers will experience profound correlation. The invention is based on the realisation that nonlinear compensation may be achieved by inserting phase-conjugated pilots across an entire OFDM band.

Herein “neighbouring” may mean directly adjacent, i.e. the next closest subcarrier, or it may be a subcarrier that is nearby, e.g. separated by any of 0, 1, 2, 3, 4, 5 or more intermediate subcarriers.

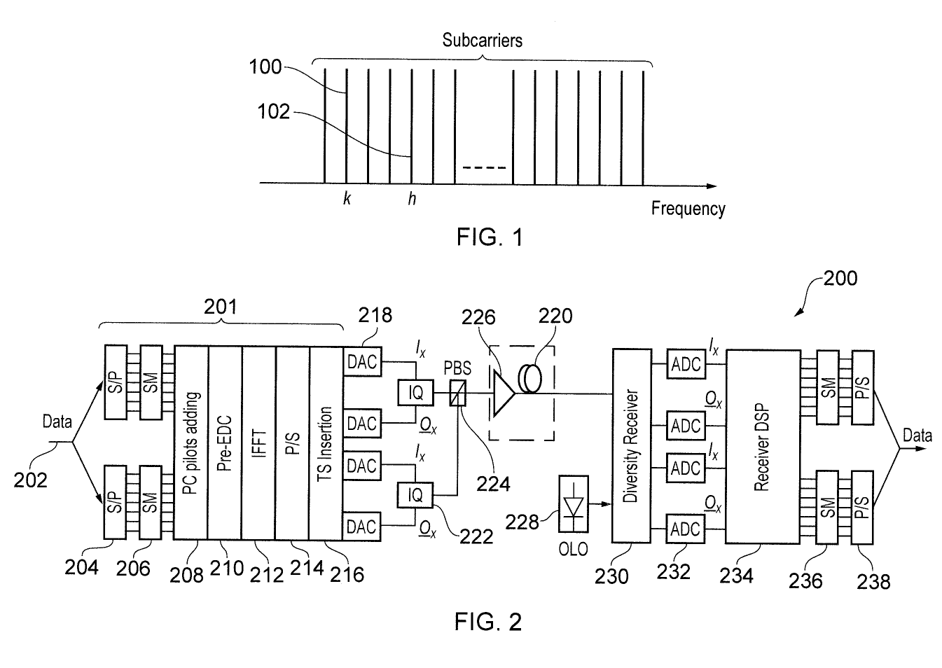

FIG. 1 illustrates the concept of inserting a phase-conjugated pilot. FIG. 1 shows a schematic frequency plot of a set of subcarriers in an CO-OFDM communication scheme. Now suppose the information symbol carried by the kth subcarrier 100 is Sₖ=Aₖexp(jφₖ), where Aₖ and φₖ are the amplitude and the phase of this information symbol, then a phase-conjugated pilot, can be transmitted in the hth subcarrier as a phase conjugate of the symbol sent via the kth subcarrier, i.e. Sₕ=S*ₖ=Aₖexp(−φₖ).

While propagating in optical fibre, nonlinear phase shifts representing by θₖ and θₕ are introduced to these subcarriers through optical Kerr effect. The received information symbols on the kth and hth subcarriers are thus Rₖ=A_{r,k}exp(jφₖ+θₖ) and Rₕ=A_{r,h}exp(−jφₖ+θₕ) respectively. If the frequency spacing between kth and hth subcarriers 100, 102 is small enough, the nonlinear phase shifts on these subcarriers would have high degree of correlation, i.e. θₖ≈θₕ. This correlation provides an opportunity to cancel the nonlinear phase shift on the kth subcarrier by averaging the received information symbols on this subcarrier and on the subcarrier that carries its phase conjugate as follows:

R̅ₖ=(Rₖ+R*ₕ)/2≈A_{r,k} cos(θₖ)exp(jφₖ) (1)

It should be noted that by transmitting a phase-conjugated pilot the nonlinear phase shift on its correlated subcarrier data can be estimated as:

θₖ=arg(RₖR*ₕ)/2 (2)

Whilst FIG. 1 shows an arrangement where the phase-conjugated pilot is separated from its base data subcarrier by another two subcarriers. It is desirable to provide the phase-conjugate pilot at only a small frequency separation from its base data subcarrier in order to minimize the frequency detuning between these subcarriers, thus increasing the probability of correlation of nonlinear phase shifts between these subcarriers. For example, the subcarrier with data may be placed directly next to its phase-conjugated pilot, or may be separated from it by a number of subcarriers, e.g. 1, 2, 3, 4, 5 or more.

The nonlinear distortion on the kth subcarrier 100 can also be estimated with the help of phase-conjugated pilot as:

δk=(Rₖ−R*ₕ)/2 (3)

The estimations represented by equations (2) and (3) can be used to compensate nonlinear distortion on other neighbouring, i.e. nearby, subcarriers. By applying this technique, the fibre nonlinearity impairments on data subcarriers in an OFDM system can be compensated without conjugating all pairs of subcarriers.

A plurality of data subcarriers and their phase conjugate pilot subcarriers may be distributed throughout the whole OFDM signal. The distribution may be regular. A plurality of data subcarriers without corresponding phase conjugate pilots may separate each data/phase-conjugated pilot subcarrier pair. The nonlinear distortions on the data subcarriers without corresponding phase conjugate pilots will be similar to the data/phase-conjugated pilot subcarrier pair if the frequency spacing is small. Thus, nonlinear distortions can be compensated in the data subcarriers without corresponding phase conjugate pilots using the estimated nonlinear distortion on the closest pair of subcarrier data and phase conjugated pilot. Thus, using this scheme one phase conjugated pilot can be used to compensate the nonlinear distortions on several subcarriers. As a result, the overhead due to phase conjugated pilots in this scheme is relatively relaxed and can be designed according to the requirement of a specific application.

Depending on the link properties, the nonlinear distortion on subcarriers that are not accompanied by phase-conjugated pilots can be estimated in various ways. The first method is to use the same estimated nonlinear distortion δk from a pair of subcarrier data and its phase conjugate to compensate the nonlinear distortion on subcarriers surrounding this pair as described above. The second method is to use linear interpolation of the estimated nonlinear distortions from two adjacent pairs of subcarrier data and its phase conjugate pilots to compensate for nonlinear distortion on subcarriers in between these two pairs. The second method is discussed further below.

The compensation technique of the invention may be enhanced by applying electrical dispersion pre-compensation (pre-EDC) to create a dispersion-symmetry along the transmission link. Having a symmetric dispersion map may enhance the similarity between nonlinear distortions on subcarrier data and its phase conjugate, thus further improving the effectiveness of nonlinearity cancellation scheme. In order to create a symmetric dispersion map, pre-EDC is applied as:

$$\overline{X} ( 0 , ω ) = X ( 0 , ω ) exp ( \frac{1}{2} \frac{D {λ}^{2}}{4 π c} {ω}^{2} L ) \qquad ( 4 )$$

where X(0,ω) is the spectrum of the transmit signal, D is the fibre dispersion, λ is the wavelength, c is the speed of light and L is the transmission distance.

In a CO-OFDM system, pre-EDC can be easily implemented in the frequency domain before IFFT block by the following expression:

$$\overline{{S}_{k}} = {S}_{k} exp ( \frac{D {λ}^{2}}{8 π c} {( k Δ f )}^{2} L ) \qquad ( 5 )$$

where k is the subcarrier index and Δf is the frequency spacing. As a result, the proposed fibre nonlinearity compensation technique can be easily combined with pre-EDC for CO-OFDM transmissions to achieve the best performance.

FIG. 2 shows the block diagram of a polarization divisional multiplexed (PDM) CO-OFDM system 200. The system comprising an transmitter side process and a receiver-side processor connected by a length of optical fibre 220. We now describe the steps taken in a simulation of the present invention.

A data stream 202 is input into a transmitter-side processor 201, which is represented in FIG. 2 as a plurality of functional blocks (referred to below as “portions” of the processor). These functions made by implemented in hardware or software, as appropriate. The input data stream 202 is divided into x- and y-polarizations, each of which is then mapped onto 1920 subcarriers via serial to parallel converting portions 204 and symbol mapping portions 206, e.g. using a quadrature phase shift keying (QPSK) modulation format. A plurality of predetermined subcarriers have a 0 mapped to them in order to reserve them for a phase conjugate.

At this stage, i.e. still in the frequency domain, a plurality of phase-conjugated pilots are added by a PCP adding portion 208. Here each of the reserved plurality of predetermined subcarriers has a phase conjugate of a respective subcarriers mapped thereto.

The functions performed by the symbol mapping portion 206 and the PCP adding portion 208 may be performed simultaneously in a single symbol mapping block, in which data and the its phase conjugates are mapped simultaneously onto data carrying subcarriers and PCPs.

Following addition of the phase-conjugated pilots, the subcarriers are subjected to electrical dispersion pre-compensation as discussed above (see e.g. equation (5)) in a pre-EDC portion 210. The subcarriers are subsequently transferred to the time domain by an inverse fast Fourier transform (IFFT) portion 212. The IFFT is of size 2048 while zeros occupy the remainder.

The subcarriers then undergo parallel to serial conversion in portion 214, before one or more training symbols are added in portion 216. The signals are then prepared for transmission by digital-to-analog converters 218, I/Q modulator 222 and polarization beam splitter 224.

The OFDM useful duration is 51.2 ns. In the simulation performed herein, the long-haul fibre link (optical fibre 220) is assumed to consist of 80 km spans of standard single mode fibre (SSMF) with the loss parameter of 0.2 dBkm⁻¹, nonlinearity coefficient of 1.22 W⁻¹km⁻¹, dispersion of 16 ps/nm/km and PMD coefficient of 0.1 ps/km^{-0.5}. The fibre span loss is compensated by an erbium-doped fibre amplifier 226 (EDFA) with 16 dB of gain and a noise figure of 4 dB.

In the simulation, amplified spontaneous emission (ASE) noise was added inline. The transmitter and receiver lasers have the same linewidth of 100 kHz. The simulated time window contains 100 OFDM symbols.

After travelling through the optical fibre 220, the signal is received by a diversity receiver 230 having an optical local oscillator (OLO) 228 connected thereto. The received signal is then prepared for interpretation by analog-to digital converters 232, which resample the signal and provide the in phase and quadrature components of the two polarisation states to a digital signal processor (DSP) 234.

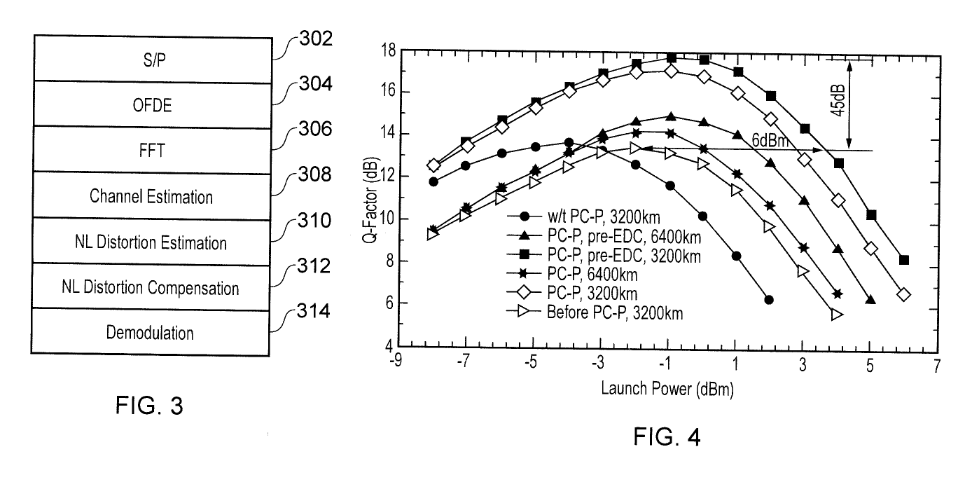

The block diagram of the receiver DSP 234 is shown in FIG. 3. The DSP 234 has a first portion 302 for converting the signal from serial to parallel for further processing, a second portion 304 for performing chromatic dispersion compensation using an overlapped frequency domain equalizer (OFDE) with overlap-save method, a third portion 306 for performing fast Fourier transform to transform the signal into the frequency domain, a fourth portion 308 for performing channel estimation and equalization with the assistance of initial training sequence using zero forcing estimation method with MIMO processing [17], a fifth portion 310 for performing nonlinear phase noise (NLPN) estimation, and a sixth portion 312 for performing NLPN compensation. The resulting information is demodulated in a seventh portion 314 and then passed to symbol mapping portions 236 to be decoded. After decoding, the data is output through appropriate parallel to serial converting portions 238.

In order to compensate for NLPN using phase conjugated pilots, it is necessary to compensate for the common phase error (CPE) introduced by the lasers' phase noise and fibre nonlinearity first. This task can also be done with the help of phase conjugated pilots as shown in [18], and is not discussed further herein.

In the simulation, after CPE compensation the nonlinear phase noises of subcarriers data accompanied by phase conjugated pilots are compensated using expression (1) and then the nonlinear phase noises of other subcarriers are compensated using expression (3) with and without linear interpolation method. This step is performed by the fifth portion 310 and a sixth portion 312, before the signal is passed to the seventh portion 314 for demodulation.

FIG. 4 is a graph that demonstrates the effect of the phase conjugated pilots used in the simulation described above by looking at the behaviour of Q factor for different launch powers. FIG. 4 compares a scheme in which 50% of the subcarriers are allocated to the phase conjugated pilots (although, as discussed above, the overhead may be less than this) with a scheme without any phase conjugated pilots. FIG. 4 also compares results obtained by additionally applying a pre-EDC technique. It can be seen that an improvement of around 4.5 dB in the system performance is achieved when pre-EDC and 50% phase conjugated pilots are used. The transmission distance in this comparison is 3200 km.

In addition, the nonlinear threshold is also increased by 6 dB when the phase conjugated pilot compensation technique is applied. This result clearly indicates that the nonlinear phase noise can be significantly mitigated by coherently averaged the phase conjugated pilot and its correlated data subcarrier. As a result of this improvement, a longer transmission distance can be achieved. FIG. 4 also shows the performance of system with 50% phase conjugated pilots after 6400 km of transmission distance. This system still offers around 1.5 dB advantage in performance in comparison with OFDM system without phase conjugated pilots after 3200 km of transmission distance. This important comparison indicates that the product of spectral efficiency and transmission distance can be significantly increased with the phase conjugated pilot technique of the invention.

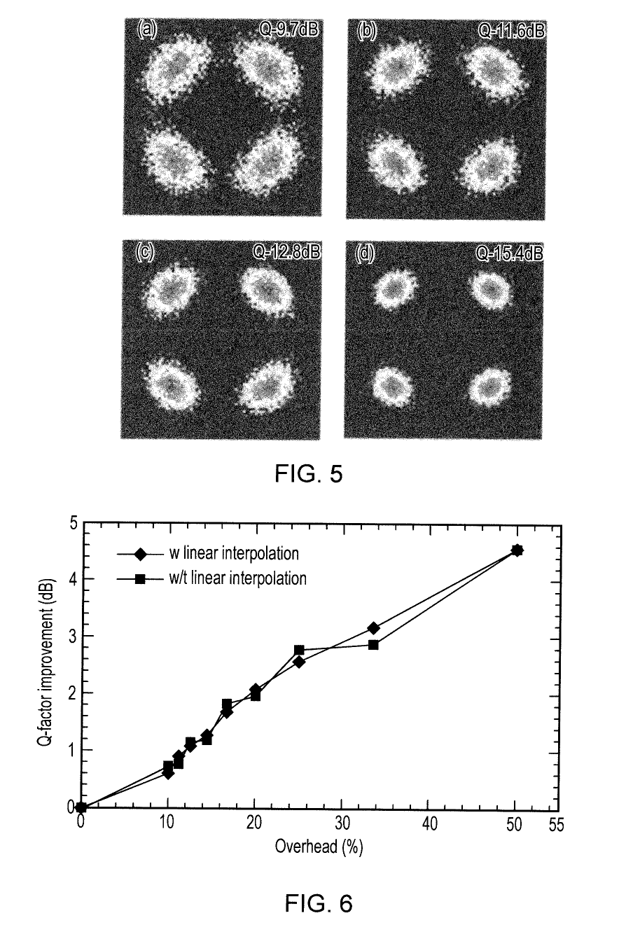

The simulation results presented in the FIG. 4 clearly indicate that the system performance can be significantly improved by transmitting each subcarrier data with its phase conjugated pilot. This implementation offers the best performance but it requires 50% overhead. It has been discussed in the previous section that the required overhead in applying phase conjugated pilot compensation technique can be reduced by using the estimated nonlinear distortion on one pair of subcarrier data and its phase conjugated pilot to compensate the nonlinear distortions on other subcarriers. Specifically, one phase conjugated pilot can be used to compensate the nonlinear distortion of 2, 3, 4 or more data subcarriers at the cost of 33%, 25%, 20% or smaller overhead respectively. In FIG. 5 the received constellation diagrams of systems without and with phase conjugated pilots for fibre nonlinearity compensation are shown for different values of phase conjugated pilot overhead. FIG. 5(a) is the received constellation diagram without any phase conjugated pilots. FIG. 5(b) is the received constellation diagram with a phase conjugated pilot overhead of 20% (each pilot compensates 4 data subcarriers); FIG. 5(c) is the received constellation diagram with a phase conjugated pilot overhead of 25% (each pilot compensates 3 data subcarriers); FIG. 5(d) is the received constellation diagram with a phase conjugated pilot overhead of 50% (each pilot compensates one data subcarrier). In this simulation the transmission distance was 1200 km and the launch power 6 dBm. The trade-off between overhead due to phase conjugated pilots and performance can be clearly observed. A better performance comes with the cost of larger overhead due to the transmission of phase conjugated pilots.

The system performance improvement in dB as a function of the overhead due to phase conjugated pilots is shown in FIG. 6. The system performance improvement is defined at the optimum launch power point. With 50%, 33%, and 20% overhead the achievable improvement in the systems performance are 4.6 dB, 3.2 dB and 2.1 dB respectively. As a result, due to the trade-off between overhead and performance improvement the proposed fibre nonlinearity compensation technique may be applied adaptively according to the optical link requirements.

As mentioned before, the estimated nonlinear distortion on a pair of subcarrier data and its phase conjugated pilot can be used to compensate nonlinear distortions on other surrounding subcarriers with and without linear interpolation method. With 50%, 33%, and 20% overhead the achievable improvement in the systems performance are around 4.6 dB, 3.2 dB and 2.1 dB respectively, or approximately 0.1 dB per 1% of overhead. In a practical system, a minimum overhead for CPE (4-10%) would be required, and this overhead may be used to provide a certain level of nonlinear compensation without additional overhead.

### REFERENCES

[1] C. E. Shannon, “A Mathematical Theory of Communication,” The Bell System Technical Journal, vol. 27, pp. 379-432, 1948.

[2] R. Essiambre, G. Kramer, P. J. Winzer, G. J. Foschini, and B. Goebel, “Capacity Limits of Optical Fiber Networks,” Lightwave Technology, Journal of, vol. 28, pp. 662-701, 2010.

[3] P. P. Mitra, Stark, Jason B., “Nonlinear limits to the information capacity of optical fibre communications,” Nature, vol. 411, pp. 1027-1030, 2001.

[4] E. Ip and J. M. Kahn, “Compensation of Dispersion and Nonlinear Impairments Using Digital Backpropagation,” Journal of Lightwave Technology, vol. 26, pp. 3416-3425, Oct. 15, 2008 2008.

[5] E. Mateo, L. Zhu, and G. Li, “Impact of XPM and FWM on the digital implementation of impairment compensation for WDM transmission using backward propagation,” Optics Express, vol. 16, pp. 16124-16137, Sep. 29, 2008 2008.

[6] D. Rafique and A. D. Ellis, “Impact of signal-ASE four-wave mixing on the effectiveness of digital back-propagation in 112 Gb/s PM-QPSK systems,” Optics Express, vol. 19, pp. 3449-3454, Feb. 14, 2011 2011.

[7] C. Xi, L. Xiang, S. Chandrasekhar, B. Zhu, and R. W. Tkach, “Experimental demonstration of fiber nonlinearity mitigation using digital phase conjugation,” in Optical Fiber Communication Conference and Exposition (OFC/NFOEC), 2012 and the National Fiber Optic Engineers Conference, 2012, pp. 1-3.

[8] S. L. Jansen, D. Van den Borne, B. Spinnler, S. Calabro, H. Suche, P. M. Krummrich, et al., “Optical phase conjugation for ultra long-haul phase-shift-keyed transmission,” Lightwave Technology, Journal of, vol. 24, pp. 54-64, 2006.

[9] D. M. Pepper and A. Yariv, “Compensation for phase distortions in nonlinear media by phase conjugation,” Optics Letters, vol. 5, pp. 59-60, Feb. 1, 1980 1980.

[10] X. Liu, Chraplyvy A. R, Winzer P. J, Tkach R. W, Chandrasekhar S., “Phase-conjugated twin waves for communication beyond the Kerr nonlinearity limit,” Nat Photon, vol. 7, pp. 560-568, 2013.

[11] W. Shieh and C. Athaudage, “Coherent optical orthogonal frequency division multiplexing,” Electronics Letters, vol. 42, pp. 587-589, 2006.

[12] S. Chandrasekhar and L. Xiang, “OFDM Based Superchannel Transmission Technology,” Lightwave Technology, Journal of, vol. 30, pp. 3816-3823, 2012.

[13] S. Chandrasekhar, L. Xiang, B. Zhu, and D. W. Peckham, “Transmission of a 1.2-Tb/s 24-carrier no-guard-interval coherent OFDM superchannel over 7200-km of ultra-large-area fiber,” in Optical Communication, 2009. ECOC '09. 35th European Conference on, 2009, pp. 1-2.

[14] A. J. Lowery, “Fiber nonlinearity pre- and post-compensation for long-haul optical links using OFDM,” Optics Express, vol. 15, pp. 12965-12970, Oct. 1, 2007 2007.

[15] L. Xiang, F. Buchali, and R. W. Tkach, “Improving the Nonlinear Tolerance of Polarization-Division-Multiplexed CO-OFDM in Long-Haul Fiber Transmission,” Lightwave Technology, Journal of, vol. 27, pp. 3632-3640, 2009.

[16] B. Inan, S. Randel, S. L. Jansen, A. Lobato, S. Adhikari, and N. Hanik, “Pilot-tone-based nonlinearity compensation for optical OFDM systems,” in Optical Communication (ECOC), 2010 36th European Conference and Exhibition on, 2010, pp. 1-3.

[17] S. L. Jansen, I. Morita, T. C. W. Schenk, and H. Tanaka, “121.9-Gb/s PDM-OFDM Transmission With 2-b/s/Hz Spectral Efficiency Over 1000 km of SSMF,” Lightwave Technology, Journal of, vol. 27, pp. 177-188, 2009.

[18] S. T. Le, T. Kanesan, E. Giacoumids, N. Doran, and A. Ellis, “Quasi-pilot Aided Phase Noise Estimation for Coherent Optical OFDM Systems,” Photonics Technology Letters, IEEE, vol. 26, pp. 504-507, 2014.

1. A method of preparing an optical data signal for transmission along an optical fibre, the method comprising: mapping a plurality of nonlinearity compensation information symbol pairs into respective pairs of subcarriers in an orthogonal frequency-division multiplexing (OFDM)-encoded data signal, each of the plurality of nonlinearity compensation information symbol pair comprising:
a data information symbol mapped to a first subcarrier; and
a complex conjugate of the data information symbol mapped to a second subcarrier,
wherein the second subcarrier neighbours the first subcarrier in the frequency domain and
wherein the proportion of subcarriers in the OFDM-encoded optical data signal which convey complex conjugates of data information symbols carried by other subcarriers is 50% or less.

2. A method according to claim 1, wherein the plurality of nonlinearity compensation information symbol pairs are regularly spaced through the frequency distribution of subcarriers in the OFDM-encoded data signal.

3. A method according to claim 1, wherein the proportion is 30% or less.

4. A method according to claim 1, wherein the first subcarrier is adjacent to the second subcarrier in a frequency distribution of subcarriers in the OFDM-encoded optical data signal.

5. A method according to claim 1 including:
applying an inverse fast Fourier transform to the OFDM-encoded data signal to generate a time-domain signal;
modulating an optical carrier with the time-domain signal; and
transmitting the optical carrier through an optical fibre.

6. A method according to claim 5, comprising applying electrical dispersion pre-compensation to the OFDM-encoded data signal.

7. A computer program product having computer-readable instructions stored thereon, which when executed by a computer cause the computer to perform a method according to claim 1.

8. A method of compensating for optical fibre nonlinearity, the method comprising:
receiving an orthogonal frequency-division multiplexing (OFDM) -encoded optical data signal from an optical fibre;
detecting a first received information symbol from a first subcarrier of the OFDM-encoded optical data signal;
detecting a second received information symbol from a second subcarrier in the OFDM-encoded optical data signal, wherein the second subcarrier neighbours the first subcarrier in the frequency domain, and wherein the second received information symbol is a phase conjugated pilot for the first received information symbol;
compensating for a nonlinear phase shift in the first received information symbol based on the second received information symbol;
calculating an estimated nonlinear distortion based on the first received information symbol and the second received information symbol;
detecting a third received information symbol from a third subcarrier of the OFDM-encoded optical data signal, wherein the third subcarrier neighbours the first subcarrier in the frequency domain, and
compensating for a nonlinear phase shift in the third received information symbol based on the estimated nonlinear distortion.

9. A method according to claim 8, wherein compensating for a nonlinear phase shift in the first received information symbol includes averaging the first received information symbol and the conjugation of the second received information symbol.

10. A method according to claim 8, wherein the first subcarrier is adjacent to the second subcarrier in a frequency distribution of subcarriers in the OFDM-encoded optical data signal.

11. A method according to claim 8 including compensating for a nonlinear phase shift in a plurality of received information symbols conveyed by a plurality of subcarriers located around the first subcarrier in the frequency domain by applying the estimated nonlinear distortion to each of the plurality of received information symbols.

12. A method of compensating for optical fibre nonlinearity, the method comprising:
receiving an orthogonal frequency-division multiplexing (OFDM) -encoded optical data signal from an optical fibre;
detecting a first pair of nonlinearity compensation information symbols from a first pair of subcarriers in the OFDM-encoded optical data signal, the first pair of nonlinearity compensation information symbols comprising:
a first received information symbol from a first subcarrier of the OFDM-encoded optical data signal, and
a second received information symbol from a second subcarrier in the OFDM-encoded optical data signal,
wherein the second subcarrier neighbours the first subcarrier in the frequency domain, and
wherein the second received information symbol is a phase conjugated pilot for the first received information symbol;
detecting a second pair of nonlinearity compensation information symbols from a second pair of subcarriers in the OFDM-encoded optical data signal, the second pair of nonlinearity compensation information symbols comprising:
a third received information symbol from a third subcarrier of the OFDM-encoded optical data signal, and
a fourth received information symbol from a fourth subcarrier in the OFDM-encoded optical data signal,
wherein the fourth subcarrier neighbours the third subcarrier in the frequency domain, and
wherein the fourth received information symbol is a phase conjugated pilot for the third received information symbol;
calculating a first estimated nonlinear distortion based on the first received information symbol and the second received information symbol;
calculating a second estimated nonlinear distortion based on the third received information symbol and the fourth received information symbol;
detecting a plurality of received information symbols conveyed by a plurality of subcarriers located between the first pair of subcarriers and the second pair of subcarriers in the frequency domain of the OFDM-encoded optical data signal; and
compensating for a nonlinear phase shift in each of the plurality of received information symbols based on the first estimated nonlinear distortion and the second estimated nonlinear distortion.

13. A method according to claim 12, wherein compensating for a nonlinear phase shift in each of the plurality of received information symbols comprises:
determining if the subcarrier of each respective received information symbol is closer to the first pair of subcarriers or the second pair of subcarriers in the frequency domain of the OFDM-encoded optical data signal;
if the subcarrier is closer to the first pair of subcarriers, applying the first estimated nonlinear distortion to its respective received information symbol; and
if the subcarrier is closer to the second pair of subcarriers, applying the second estimated nonlinear distortion to its respective received information symbol.

14. A method according to claim 12 including interpolating a linear variation of estimated nonlinear distortion with frequency based on the first estimated nonlinear distortion and the second estimated nonlinear distortion, wherein compensating for a nonlinear phase shift in each of the plurality of received information symbols comprises applying an interpolated estimated nonlinear distortion to each of the plurality of received information symbols based on the frequency of its subcarrier.

15. A computer program product having computer-readable instructions stored thereon, which when executed by a computer cause the computer to perform a method according to claim 8.
